(19) United States
(12) Patent Application Publication
(10) Pub. No.: US 2024/0367483 A1
(43) Pub. Date: Nov. 7, 2024

(54) THERMAL MANAGEMENT SYSTEM FOR A VEHICLE, VEHICLE COMPRISING A THERMAL MANAGEMENT SYSTEM, USE OF A THERMAL MANAGEMENT SYSTEM, METHOD FOR CONTROLLING A THERMAL MANAGEMENT SYSTEM AND COMPUTER PROGRAM ELEMENT

(71) Applicant: Volvo Car Corporation, Gothenburg (SE)

(72) Inventors: Morgan Halldin, Göteborg (SE); Jesper Hermanson, Göteborg (SE)

(21) Appl. No.: 18/649,507

(22) Filed: Apr. 29, 2024

(30) Foreign Application Priority Data
May 3, 2023 (EP) 23171412.2

(51) Int. Cl. B60H 1/00

(52) U.S. Cl. CPC B60H 1/00828

(57) ABSTRACT

The disclosure relates to a thermal management system for a vehicle. The thermal management system can comprise at least one degassing pipe comprising at least one degassing pipe end and a filling pipe. The at least one degassing pipe can be connected to a degassing tank by means of at least one connecting port being arranged at a side wall of the degassing tank. The filling pipe can be connected to the degassing tank by means of a filling port being arranged at the bottom of the degassing tank. The at least one degassing pipe end can be arranged below a limit level of the degassing tank and at a first distance from the filling port of the filling pipe.

### CROSS REFERENCE TO RELATED APPLICATIONS

This application claims the benefit of and priority to pending EP patent application Ser. No. 23/171,412.2, filed May 3, 2023, and entitled “THERMAL MANAGEMENT SYSTEM FOR A VEHICLE, VEHICLE COMPRISING A THERMAL MANAGEMENT SYSTEM, USE OF A THERMAL MANAGEMENT SYSTEM, METHOD FOR CONTROLLING A THERMAL MANAGEMENT SYSTEM AND COMPUTER PROGRAM ELEMENT,” the entirety of which is hereby incorporated by reference herein.

### TECHNICAL FIELD

The present disclosure relates to vehicles and, more particularly, to a thermal management system for a vehicle.

### SUMMARY

The present disclosure relates to a thermal management system for a vehicle, a vehicle comprising a thermal management system, use of a thermal management system for a flow and/or pressure balancing system of a vehicle, a method for controlling a thermal management system for a vehicle and a computer program element for a thermal management system.

In the modern vehicle industry, in particular in the battery electric vehicles, energy efficiency becomes an increasingly important factor while travelling. An energy efficient and compact thermal management system as well as a solution to couple valves which may connect heat sources in an efficient way are desired.

It is an objective of the present disclosure to provide an improved thermal management system for a vehicle.

The problem is at least partially solved or alleviated by the subject matter of the independent claims of the present disclosure, wherein further examples are incorporated in the dependent claims.

According to a first aspect, there is provided a thermal management system for a vehicle. The thermal management system comprises at least one degassing pipe, which comprises at least one degassing pipe end, and a filling pipe. The at least one degassing pipe is connected to a degassing tank by means of the at least one connecting port, and the at least one connecting port is arranged at a side wall of the degassing tank. The filing pipe is connected to the degassing tank by means of a filling port, and the filling port is arranged at the bottom of the degassing tank.

The at least one degassing pipe end of the at least one degassing pipe is arranged below a limit level of the degassing tank. Additionally, the at least one degassing pipe end is arranged at a first distance from the filling port of the filling pipe.

The limit level of the degassing tank may be a predefined limit level of the degassing tank. And the first distance from the filling port of the filling pipe may be a first predefined distance from the filling port of the filling pipe.

The at least one degassing pipe may comprise one or more degassing pipes, for example two degassing pipes, namely a first degassing pipe and a second degassing pipe. For example, the two degassing pipes may be connected, respectively, to a certain thermal circuit which may comprise a radiator or electric drive components.

For example, the predefined limit level of the degassing tank or expansion tank may be a minimum filling level of the degassing tank. Regardless of the arrangement of the at least one connecting port at the side wall of the degassing tank for connecting the at least one degassing pipe, the at least one degassing pipe may end inside the degassing tank below the minimum filling level, in order to reduce risk of sucking in air at any driving condition of the vehicle.

Moreover, with the first predefined distance between the at least one degassing pipe end and the filling port of the filling pipe, the at least one degassing pipe, in particular the at least one degassing pipe end, may be placed distantly or far away from the filling line, so that no air will be sucked down into any of the at least one degassing pipe at any driving condition of the vehicle.

It may be provided that the degassing tank may be divided into a plurality of sections where the degassing process and the filling process may be separated from each other, so that the air may have time to be evacuated or degassed to the surface of the filling fluid inside the tank before the filling fluid may exit the tank.

According to an example, the filling pipe may comprise a larger dimension than the at least one degassing pipe.

For example, the dimension of the filing pipe may be a diameter, a radius or a further size parameter of the filing pipe. For example, the filling pipe may comprise an inner diameter of 8 to 30 mm, preferably 10 to 20 mm, more preferably 16 mm. In contrast, one of the degassing lines may comprise an inner diameter of 4 to 12 mm, preferably 6 to 8 mm, while the other degassing line may comprise an inner diameter of 1 to 8 mm, preferably 2 to 4 mm.

The large dimension of the filling pipe may advantageously enable or optimize the filling efficiency and/or the filling rate of the filling fluid into the degassing tank.

According to another example, the at least one degassing pipe may comprise a first degassing pipe, which may comprise a first degassing pipe end, and a second degassing pipe, which may comprise a second degassing pipe end.

The first degassing pipe may be connected to the degassing tank by means of the first connecting port. Alternatively or additionally, the second degassing pipe may be connected to the degassing tank by means of the second connecting port.

According to another example, the degassing tank may comprise the first connecting port and/or the second connecting port. The first connecting port and/or the second connecting port may be arranged in the top region and/or in the bottom region of the side wall of the degassing tank.

According to another example, the first degassing pipe end may be arranged at a second distance from the second degassing pipe end.

A second distance from the second degassing pipe end may be a second predefined distance from the second degassing pipe end.

The first degassing pipe end and the second degassing pipe end may be arranged distantly or far away from each other, for example, in order to prevent the first and second degassing pipes from sucking down any air in the tank into the thermal management system. In addition, with the second predefined distance arranged between the first and second degassing pipe ends, the flow in the vicinity of the first and second degassing pipe ends may be prevented from a potential flow interference or flow turbulence. As a result, the flow in each of the first and second degassing pipes may be controlled, respectively, at a flow rate or a predefined flow rate.

According to another example, the first connecting port and the second connecting port may be arranged on the same side of the side wall of the degassing tank. Further, the first connecting port may be arranged at a lower position at the side wall than the second connecting port.

In other words, the first connecting port and the second connecting port may be arranged, respectively, at a different height of the same side wall of the degassing tank.

According to another example, the second connecting port may be arranged on an opposite side of the side wall to the first connecting port. Alternatively or additionally, the first connecting port may be arranged at a lower or higher position at the side wall than the second connecting port.

Accordingly, the first connecting port and the second connecting port may be arranged to be distant from each other in both lateral and vertical directions. As such, the first connecting port and the second connecting port may have different heights and different lateral positions at the side wall of the degassing tank. Alternatively, the first connecting port and the second connecting port may be arranged at the same height but at a different side or at the opposite sides of the side wall of the degassing tank.

The first connecting port and the second connecting port may be placed far away, for example at least approximately 5 cm, from each other to prevent air suction into the first and second degassing pipes.

According to another example, the thermal management system may further comprise at least one restriction unit, which may be arranged along the at least one degassing pipe. The at least one restriction unit may be configured to restrict at least one degassing flow inside the at least one degassing pipe at a predefined degassing flow rate by setting a dimension of the restriction.

The degassing flow rate may be a predefined degassing flow rate.

Further, the at least one restriction unit may be configured to adjust in a correct way to balance the flow through the degassing tank and at the same time to adjust the pressure to the inlet of a pumping system that may be connected to the at least one degassing pipe and/or the filling pipe.

It may be provided that, if two degassing pipes, namely the first degassing pipe and the second degassing pipe are arranged for the thermal management system, only one restriction unit may be arranged along one of the two degassing pipes. While the degassing flow rate inside the degassing pipe without the restriction unit may remain at a certain degassing flow rate, the degassing flow rate inside the degassing pipe with the restriction unit may be varied by setting or adapting the dimension of the restriction depending on the pressure inside the degassing tank, the filling rate inside the filling pipe and/or the degassing flow rate inside the other degassing pipe without the restriction unit.

Alternatively, each of the first and second degassing pipes may be provided with a separate restriction unit. As such, the at least one restriction unit may comprise for example two restriction units, namely a first restriction unit for the first degassing pipe and a second restriction unit for the second degassing pipe. The degassing flow inside the first and second degassing pipes may be restricted, respectively, at different degassing flow rates by separately setting the dimensions of the first and second restriction units.

According to another example, the thermal management system may further comprises a control unit, which may be configured to control the at least one restriction unit and to adjust the dimension of the restriction, so that the at least one degassing flow inside the at least one degassing pipe may vary depending on a filling flow rate of the filling pipe and/or a gas pressure inside the degassing tank and/or a pressure to an inlet of a pumping system being connected to the at least one degassing pipe and/or the filling pipe.

While the filling pipe may be connected to the pumping system that may be electrically connected to and driven by a battery system comprising battery circuit components, the first degassing pipe may be connected to the electric drive components that may be provided in the thermal circuit and the second degassing pipe may be connected to the radiator provided in the thermal circuit. The radiator and the electric drive components may be arranged in two separate sections or paths of the thermal circuit. Further, valves may be arranged in the thermal circuit.

With the thermal circuit having multiple thermal paths connected to the expansion tank or the degassing tank via the first and second degassing pipes and the filling pipe, the degassing and filling flows may vary depending on the control unit, the restriction units and/or the valve setting. As such, the degassing solution for the thermal management of the vehicle may be improved with efficient and effective degassing and filling controls in combination with not creating critical pressure levels for the pumping system and leakage that may cause drop in energy efficiency.

According to a second aspect, there is provided a vehicle that comprises a thermal management system according to the present disclosure.

According to a third aspect, there is provided a use of a thermal management system according to the present disclosure for a flow and/or pressure balancing system of a vehicle according to the present disclosure.

The thermal management system having, for example, two degassing pipes and one filling line, may be configured be create a beneficial pressure situation depending on parameters, such as the location of the connecting ports and/or the degassing pipe ends of the degassing pipes as well as dimensions of one or more restriction units arranged along the at least one degassing pipes.

As a result, the thermal management system may be improved with an optimized degassing efficiency and reliability as well as a well-balanced degassing and filling of the degassing tank. Further, by arranging the first and second degassing pipes and their ends relative to each other and to the filling pipe and by arranging the at least one restriction unit being able to be controlled by the control unit, the thermal management system may provide effective thermal expansion from all circuits in all valve configurations. In particular, the thermal management system according to the present disclosure may be adjusted, so that the thermal management system and the connected thermal circuit of the vehicle may not risk cavitation at high enough pressure in front of the pumping system and may not be overengineered with the ingoing components at low enough pressure in the systems. Additionally, the energy efficiency may be increased with low enough leakage in the thermal management system.

According to a fourth aspect, there is provided a method for controlling a thermal management system for a vehicle. The method comprises the following steps: first, connecting at least one degassing pipe comprising at least one degassing pipe end to a degassing tank by means of at least one connecting port, which are arranged at a side wall of the degassing tank; subsequently, connecting a filling pipe to the degassing tank by means of a filling port, which is arranged at the bottom of the degassing tank; finally, arranging the at least one degassing pipe end below a limit level of the degassing tank and at a first distance from the filling port of the filling pipe.

According to an example, the method may further comprise the following steps: arranging the second connecting port on the same side as or on an opposite side to the first connecting port at the side wall of the degassing tank; providing the at least one degassing pipe with a first degassing pipe that may comprise a first degassing pipe end and a second degassing pipe that may comprise a second degassing pipe end; connecting the first degassing pipe to the degassing tank by means of the first connecting port, and/or connecting the second degassing pipe to the degassing tank by means of the second connecting port; and arranging the first degassing pipe end at a second distance from the second degassing pipe end.

According to another example, the method may further comprise the following steps: arranging at least one restriction unit along the at least one degassing pipe and controlling the at least one restriction unit by means of a control unit and adjusting the dimension of the restriction, so that the at least one degassing flow inside the at least one degassing pipe may vary depending on a filling flow rate of the filling pipe and/or a gas pressure inside the degassing tank and/or a pressure to an inlet of a pumping system being connected to the at least one degassing pipe and/or the filling pipe.

According to a fifth aspect, there is provided a computer program element for a thermal management system according to the present disclosure, which, when being executed by a processing element of a vehicle, is adapted to perform the method steps of the fourth aspect.

The method may be at least partly computer-implemented, and may be implemented in software or in hardware, or in software and hardware. Further, the method may be carried out by computer program instructions running on means that provide data processing functions. The data processing means may be a suitable computing means, such as an electronic control module etc., which may also be a distributed computer system. The data processing means or the computer, respectively, may comprise one or more of a processor, a memory, a data interface, or the like.

It should be noted that the above examples may be combined with each other irrespective of the aspect involved. Accordingly, the method may be combined with structural features and, likewise, the apparatus and the system may be combined with features described above with regard to the method.

These and other aspects of the present disclosure will become apparent from and elucidated with reference to the examples described hereinafter.

### BRIEF DESCRIPTION OF THE DRAWINGS

Examples of the disclosure will be described in the following with reference to the following drawings.

FIG. 1 shows schematically an example of a thermal management system according to the present disclosure.

FIG. 2 shows schematically an example of a thermal management system according to the present disclosure.

FIG. 3a shows schematically an example of a thermal management system according to the present disclosure.

FIG. 3b shows a graph illustrating current signals of a thermal management system according to the present disclosure.

FIG. 4 shows schematically an example of a vehicle according to the present disclosure.

FIG. 5 shows schematically a flow chart illustrating a method for evaluating an impedance of a battery system for a vehicle according to the present disclosure.

### DETAILED DESCRIPTION

The figures are merely schematic representations and serve only to illustrate examples of the disclosure. Identical or equivalent elements are in principle provided with the same reference signs.

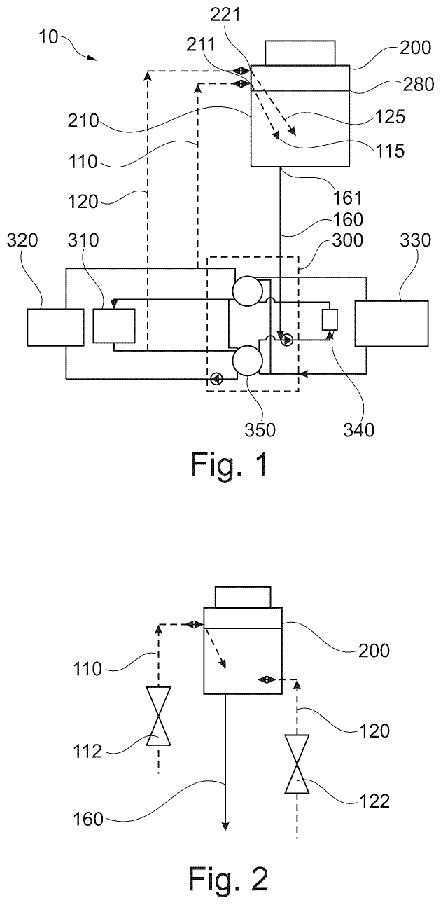

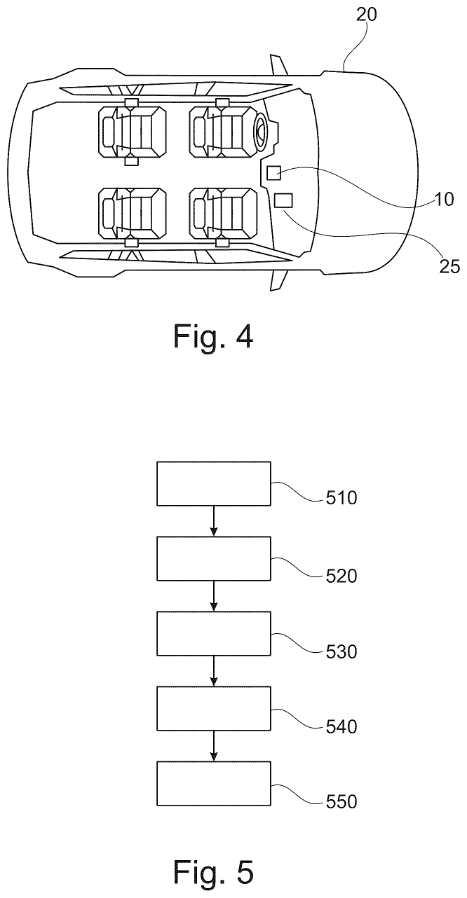

FIG. 1 shows a thermal management system 10 for a vehicle 20, which may be an electric vehicle in the present example (as shown in FIG. 4). The thermal management system 100 comprises at least one degassing pipe, in particular, a first degassing pipe 110 and a second degassing pipe 120, and a filling pipe 160.

The first degassing pipe 110 may be connected to an expansion tank or a degassing tank 200 by means of a first connecting port 211, and the second degassing pipe 110 may be connected to the degassing tank 200 by means of a second connecting port 221. Both the first and the second connecting ports 211, 221 are arranged at a side wall 210 of the degassing tank 200.

The filling pipe 160 may be connected to the degassing tank 200 via a filling port 161, which may be arranged at the bottom of the degassing tank 200. The filling pipe 160 may also be connected to a pumping system 300, which may be driven by a connected battery system 330.

The first degassing pipe 110 comprises a first degassing pipe end 115, and the second degassing pipe 120 comprises a second degassing pipe end 125. The first degassing pipe 100 and the second degassing pipe 120 are connected to the degassing tank 200, respectively, by means of the first connecting port 211 and the second connecting port 221. The at least one degassing pipes 110, 120 may also be connected, respectively, to different paths of the thermal circuit of the vehicle. For example, two paths of the thermal circuit may be provided, respectively, with a radiator 310 or electric drive components 320. The thermal circuit may further comprise a chiller 340, which may use a coolant to remove heat of the thermal circuit and the thermal management system, and a plurality of valves 350 for regulating the paths of the thermal circuit.

The first and second degassing pipes 115, 125 are both arranged below a predefined limit level 280, which may be a minimum filling level of the degassing tank 200. Regardless of the arrangement of the first and second connecting ports 211, 221 at the side wall 210 of the degassing tank 200, the first and second degassing pipes 110, 120 may end inside the degassing tank 200 below the minimum filling level 280, in order to reduce any risk of sucking in air at any driving condition of the vehicle 20.

Additionally, the first and the second degassing pipe ends 115, 225 may be arranged at a first predefined distance from the filling port 161 of the filling pipe 160. As such, the first and second degassing pipe ends 115, 125 may be placed distantly or far away from the filling line 160, so that air may not be sucked down into any of the first and second degassing pipes 110, 120 at any driving condition of the vehicle.

Alternatively, it may be provided that the degassing tank 200 may be divided into a plurality of sections (not shown) where the degassing process and the filling process may be separated from each other, so that the air may have time to be evacuated or degassed to the surface of the filling fluid inside the tank before the filling fluid may exit the tank 200.

The filling pipe 160 may comprise a larger dimension than the first and second degassing pipes 110, 120. For example, the filling pipe 160 may comprise an inner diameter of 8 to 30 mm, preferably 10 to 20 mm, more preferably 16 mm. In contrast, one of the degassing lines 110, 120 may comprise an inner diameter of 4 to 12 mm, preferably 6 to 8 mm, while the other degassing line may comprise an inner diameter of 1 to 8 mm, preferably 2 to 4 mm. The large dimension of the filling pipe 160 may advantageously enable or optimize the filling efficiency and/or the filling rate of the filling fluid into the degassing tank 200.

As shown in FIG. 1, the first connecting port 211 and the second connecting port 221 may be arranged in the top region and/or in the bottom region of the side wall 210 of the degassing tank 200. Further, the first connecting port 211 and the second connecting port 221 are arranged on the same side of the side wall 210 of the tank 200. The first connecting port 211 is arranged at a lower position at the side wall 210 than the second connecting port 221. In other words, the first and second connecting ports 211, 221 are arranged at different heights along the same side of the side wall 210.

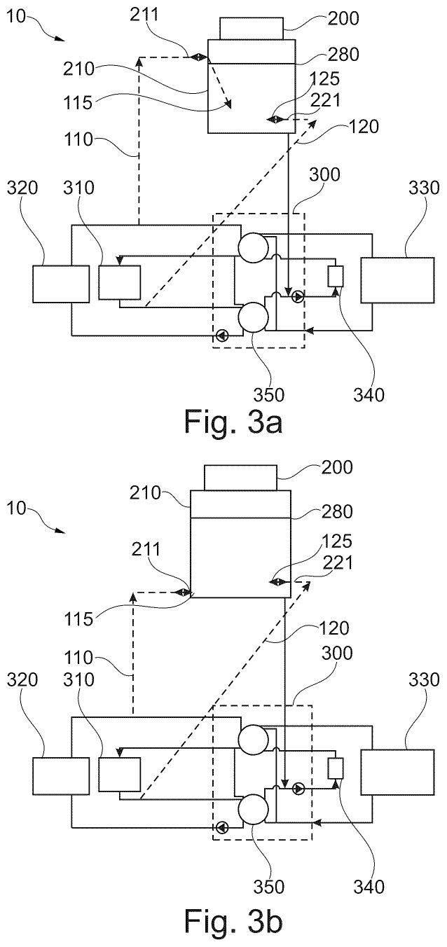

As a comparison, as shown in FIG. 2, FIG. 3a and FIG. 3b, the first connecting port 211 and/or the second connecting port 221 may be arranged in the top region or in the bottom region of the side wall 210 of the degassing tank 200. In particular, in FIG. 3a, the first connecting port 211 is arranged in the top region, while the second connecting port 221 is arranged in the bottom region. FIG. 3b shows that both the first and second connecting ports 211, 221 are arranged in the bottom region.

FIG. 3a and FIG. 3b show, respectively, that the second connecting port 221 is arranged on a different lateral position or on an opposite side of the side wall 210 to the first connecting port 211. Additionally, the first connecting port 211 may be arranged at a higher position, as shown in FIG. 3a, or lower position, as shown in FIG. 3b, at the side wall 210 than the second connecting port 221.

In general, the first degassing pipe end 115 may be arranged at a second predefined distance from the second degassing pipe end 125. The first and second degassing pipe ends 115, 125 may be arranged distantly or far away from each other, for example at least approximately 5 cm, in order to prevent the first and second degassing pipes 110, 120 from sucking down any air in the tank into the thermal management system 10. In addition, with the second predefined distance arranged between the first and second degassing pipe ends 115, 125, the flow in the vicinity of the first and second degassing pipe ends 115, 125 may be prevented from a potential flow interference or flow turbulence. As a result, the flow in each of the first and second degassing pipes 110, 120 may be controlled, respectively, at a predefined flow rate.

FIG. 2 shows a further example of a thermal management system 100, which further comprises at least one restriction unit, in particular, a first restriction unit 112 and a second restriction unit 122. The first restriction unit 112 and the second restriction unit 122 are arranged, respectively, along the first degassing pipe 110 and the second degassing pipe 120.

The first restriction unit 112 and the second restriction unit 122 comprises, respectively, an adjustable or predefined dimension of the restriction, and are configured to restrict, respectively, the degassing flows inside each degassing pipe 110, 120, at a respective degassing flow rate by setting the dimension of the restriction. In this way, the first and second restriction units 112, 122 may be configured to adjust in a correct way to balance the flow through the degassing tank 200 and at the same time to adjust the pressure to the inlet of the pumping system 300 connected to the filling pipe 160.

Moreover, the thermal management system 10 may further comprises a control unit (not shown), which may be configured to control the first and/or second restriction units 112, 122 and to adjust the dimension of the restriction, so that the degassing flows inside the degassing pipes 110, 120 may vary depending on a filling flow rate of the filling pipe 160 and/or a gas pressure inside the degassing tank 200 and/or a pressure to an inlet of a pumping system 300.

By controlling the thermal management system 10 and the thermal circuit using the control unit, the restriction units 112, 122 and/or the valve settings along the paths of the thermal circuit, the degassing solution for the thermal management of the vehicle may be improved with efficient and effective degassing and filling controls in combination with not creating critical pressure levels for the pumping system 300 and leakage that may cause drop in energy efficiency.

FIG. 4 shows the vehicle 20 that comprises a thermal management system 10 according to the present disclosure and a processing element 25, which may be designed to execute a computer program element for the thermal management system 10 for performing method steps as shown in FIG. 5.

FIG. 5 shows a flow chart illustrating a method for controlling a thermal management system 10 for a vehicle 20. The method starts at step 510 where at least one degassing pipe 110, 120 comprising at least one degassing pipe end 115, 125 is connected to a degassing tank 200 by means of at least one connecting port 211, 221. The at least one connecting port 211, 221 is arranged at a side wall 210 of the degassing tank 200.

At a subsequent step 520, a filling pipe 160 is connected to the degassing tank 200 by means of a filling port 161, which is arranged at the bottom 260 of the degassing tank 200.

At a further step 530, the at least one degassing pipe end 115, 125 is arranged below a predefined limit level 280 of the degassing tank 200 and at a first predefined distance from the filling port 161 of the filling pipe 160.

The second connecting port 221 may be arranged on the same side as or on an opposite side to the first connecting port 211 at the side wall 210 of the degassing tank 200. It may be provided that the at least one degassing pipe 110, 120 may have a first degassing pipe 110, comprising a first degassing pipe end 115, and a second degassing pipe 120, comprising a second degassing pipe end 125. Further, the first degassing pipe 110 may be connected to the degassing tank 200 by means of the first connecting port 211, and/or the second degassing pipe 120 may be connected to the degassing tank 200 by means of the second connecting port 221.

At a further step 540, the first degassing pipe end 115 may be arranged at a second distance or a second predefined distance from the second degassing pipe end 125.

Furthermore, at least one restriction unit 112, 122 may be arranged along the at least one degassing pipe 110, 120.

At a further step 550, the at least one restriction unit 112, 122 may be controlled by means of a control unit and the dimension of the restriction may be adjusted, so that the at least one degassing flow inside the at least one degassing pipe 110, 120 may vary depending on a filling flow rate of the filling pipe 160 and/or a gas pressure inside the degassing tank 200 and/or a pressure to an inlet of a pump 300 being connected to the at least one degassing pipe 110, 120.

Other variations to the disclosed examples can be understood and effected by those skilled in the art in practicing the claimed disclosure, from the study of the drawings, the disclosure, and the appended claims. In the claims the word “comprising” does not exclude other elements or steps and the indefinite article “a” or “an” does not exclude a plurality. A single processor or other unit may fulfill the functions of several items or steps recited in the claims. The mere fact that certain measures are recited in mutually different dependent claims does not indicate that a combination of these measures cannot be used to advantage. A computer program may be stored/distributed on a suitable medium such as an optical storage medium or a solid-state medium supplied together with or as part of other hardware, but may also be distributed in other forms, such as via the Internet or other wired or wireless telecommunication systems. Any reference signs in the claims should not be construed as limiting the scope of the claims.

### LIST OF REFERENCE SIGNS

10 thermal management system
20 vehicle
25 processing element
110 first degassing pipe
115 first degassing pipe end
120 second degassing pipe
125 second degassing pipe end
160 filling pipe
161 filing port
200 degassing tank
210 side wall
211 first connecting port
221 second connecting port
280 limit level
300 pumping system
310 radiator
320 electric drive components
330 battery system
340 chiller
350 valve
510 step of connecting at least one degassing pipe to degassing tank
520 step of connecting filling pipe to degassing tank
530 step of arranging at least one degassing pipe end below a limit level
540 step of arranging first degassing pipe end at a second distance from second degassing pipe end
550 step of controlling at least one restriction unit by means of control unit

What is claimed is:

1. A thermal management system for a vehicle, comprising:
at least one degassing pipe comprising at least one degassing pipe end; and
a filling pipe,
wherein the at least one degassing pipe is connected to a degassing tank by means of at least one connecting port, and the at least one connecting port is arranged at a side wall of the degassing tank,
wherein the filling pipe is connected to the degassing tank by means of a filling port, and the filling port is arranged at the bottom of the degassing tank,
wherein the at least one degassing pipe end is arranged below a limit level of the degassing tank, and
wherein the at least one degassing pipe end is arranged at a first distance from the filling port of the filling pipe.

2. The thermal management system of claim 1,
wherein the filling pipe comprises a larger dimension than the at least one degassing pipe.

3. The thermal management system according to claim 1,
wherein the at least one degassing pipe comprises:
a first degassing pipe comprising a first degassing pipe end; and
a second degassing pipe comprising a second degassing pipe end,
wherein the first degassing pipe is connected to the degassing tank by means of a first connecting port, and
the second degassing pipe is connected to the degassing tank by means of a second connecting port.

4. The thermal management system of claim 3,
wherein the degassing tank comprises the first connecting port and the second connecting port,
wherein the first connecting port is arranged in a top region or a bottom region of the side wall of the degassing tank, and
wherein the second connecting port is arranged in the top region or the bottom region of the side wall of the degassing tank.

5. The thermal management system of claim 4,
wherein the degassing tank comprises the first connecting port or the second connecting port,
wherein the first connecting port is arranged in the top region or the bottom region of the side wall of the degassing tank, and
wherein the second connecting port is arranged in the top region or the bottom region of the side wall of the degassing tank.

6. The thermal management system of claim 3,
wherein the first degassing pipe end is arranged at a second distance from the second degassing pipe end.

7. The thermal management system of claim 4,
wherein the first connecting port and the second connecting port are arranged on the same side of the side wall of the degassing tank, and
wherein the first connecting port is arranged at a lower position at the side wall than the second connecting port.

8. The thermal management system according to claim 4,
wherein the second connecting port is arranged on an opposite side of the side wall to the first connecting port, and
wherein the first connecting port is arranged at a lower or higher position at the side wall than the second connecting port.

9. The thermal management system according to claim 4,
wherein the second connecting port is arranged on an opposite side of the side wall to the first connecting port, or
wherein the first connecting port is arranged at a lower or higher position at the side wall than the second connecting port.

10. The thermal management system of claim 1, further comprising:
at least one restriction unit,
wherein the at least one restriction unit is arranged along the at least one degassing pipe, and
wherein the at least one restriction unit is configured to restrict at least one degassing flow inside the at least one degassing pipe at a degassing flow rate by setting a dimension of a restriction.

11. The thermal management system of claim 10, further comprising:
a control unit,
wherein the control unit is configured to control the at least one restriction unit and to adjust the dimension of the restriction, so that the at least one degassing flow inside the at least one degassing pipe varies depending on at least one parameter selected from a group consisting of a filling flow rate of the filling pipe, a gas pressure inside the degassing tank, a pressure to an inlet of a pumping system being connected to the at least one degassing pipe and the filling pipe.

12. A vehicle, comprising:
a thermal management system, comprising:
at least one degassing pipe comprising at least one degassing pipe end; and
a filling pipe,
wherein the at least one degassing pipe is connected to a degassing tank by means of at least one connecting port, and the at least one connecting port is arranged at a side wall of the degassing tank,
wherein the filling pipe is connected to the degassing tank by means of a filling port, and the filling port is arranged at the bottom of the degassing tank,
wherein the at least one degassing pipe end is arranged below a limit level of the degassing tank, and
wherein the at least one degassing pipe end is arranged at a first distance from the filling port of the filling pipe.

13. The vehicle of claim 12, wherein the thermal management system is used for a flow or pressure balancing system of the vehicle.

14. The vehicle of claim 13, wherein the thermal management system is used for the flow and the pressure balancing system of the vehicle.

15. A method for controlling a thermal management system for a vehicle, the method comprising:
connecting at least one degassing pipe comprising at least one degassing pipe end to a degassing tank by means of at least one connecting port, wherein the at least one connecting port is arranged at a side wall of the degassing tank;
connecting a filling pipe to the degassing tank by means of a filling port, wherein the filling port is arranged at the bottom of the degassing tank;
arranging the at least one degassing pipe end below a limit level of the degassing tank and at a first distance from the filling port of the filling pipe.

16. The method of claim 15, further comprising:
arranging a second connecting port on the same side as or on an opposite side to the first connecting port at the side wall of the degassing tank;
providing the at least one degassing pipe with a first degassing pipe comprising a first degassing pipe end and a second degassing pipe comprising a second degassing pipe end;
connecting the first degassing pipe to the degassing tank by means of the first connecting port, or connecting the second degassing pipe to the degassing tank by means of the second connecting port; and
arranging the first degassing pipe end at a second distance from the second degassing pipe end.

17. The method of claim 15, further comprising:
arranging at least one restriction unit along the at least one degassing pipe; and
controlling the at least one restriction unit by means of a control unit and adjusting a dimension of a restriction, so that at least one degassing flow inside the at least one degassing pipe varies depending on at least one parameter selected from a group consisting of a filling flow rate of the filling pipe, a gas pressure inside the degassing tank, a pressure to an inlet of a pumping system being connected to the at least one degassing pipe and the filling pipe.

18. A computer program element for a thermal management system, wherein the computer program element is executable by a processing element of a vehicle, to cause the processing element to:
connect at least one degassing pipe comprising at least one degassing pipe end to a degassing tank by means of at least one connecting port, wherein the at least one connecting port is arranged at a side wall of the degassing tank;
connect a filling pipe to the degassing tank by means of a filling port, wherein the filling port is arranged at the bottom of the degassing tank; and
arrange the at least one degassing pipe end below a limit level of the degassing tank and at a first distance from the filling port of the filling pipe.

19. The computer program element of claim 18, wherein the computer program element is further executable by the processing element of the vehicle, to cause the processing element to:
arrange the second connecting port on the same side as or on an opposite side to a first connecting port at the side wall of the degassing tank;
provide the at least one degassing pipe with a first degassing pipe comprising a first degassing pipe end and a second degassing pipe comprising a second degassing pipe end;
connect the first degassing pipe to the degassing tank by means of the first connecting port, or connecting the second degassing pipe to the degassing tank by means of the second connecting port; and
arrange the first degassing pipe end at a second distance from the second degassing pipe end.

20. The computer program element of claim 18, wherein the computer program element is further executable by the processing element of the vehicle, to cause the processing element to:
arrange at least one restriction unit along the at least one degassing pipe; and
control the at least one restriction unit by means of a control unit and adjusting the dimension of a restriction, so that the at least one degassing flow inside the at least one degassing pipe varies depending on at least one parameter selected from a group consisting of a filling flow rate of the filling pipe, a gas pressure inside the degassing tank, a pressure to an inlet of a pumping system being connected to the at least one degassing pipe, and the filling pipe.
